(19) United States
(12) Patent Application Publication
(10) Pub. No.: US 2025/0286209 A1
(43) Pub. Date: Sep. 11, 2025

(54) BATTERY PACK

(71) Applicant: TOYOTA JIDOSHA KABUSHIKI KAISHA, Toyota-shi (JP)

(72) Inventors: Shigeyuki INOUE, Toyota-shi (JP); Hiroya Takahashi, Toyota-shi (JP); Hazuki Hitomi, Obu-shi (JP); Kazuki Sugie, Miyoshi-shi (JP)

(73) Assignee: TOYOTA JIDOSHA KABUSHIKI KAISHA, Toyota-shi (JP)

(21) Appl. No.: 19/060,874

(22) Filed: Feb. 24, 2025

(30) Foreign Application Priority Data
Mar. 11, 2024 (JP) 2024-037251

(51) Int. Cl. H01M 50/358; B60R 16/04; H01M 10/613; H01M 10/625; H01M 10/6556; H01M 50/204; H01M 50/249; H01M 50/367

(52) U.S. Cl. CPC H01M 50/358; B60R 16/04; H01M 10/613; H01M 10/625; H01M 10/6556; H01M 50/204; H01M 50/249; H01M 50/367; H01M 2200/20; H01M 2220/20

(57) ABSTRACT

A battery pack according to the disclosure is mounted on a vehicle, and includes: when the battery pack is mounted under a vehicle cabin of the vehicle, a plurality of battery cells stacked in the front-rear direction thereof; a case accommodating the battery cells; a cooler having a tube through which a cooling medium is able to flow; and a share panel disposed downward of the case. Each of the battery cells has a cell opening and a cell valve. The cell opening is provided in a bottom surface of the battery cell. The cell valve is installed at the cell opening. The case has a case opening communicating with the cell opening. The case opening is provided in a bottom surface of the case. The cooler is installed on the periphery of the case opening. A smoke exhaust path is formed between the case and the share panel.

### CROSS-REFERENCE TO RELATED APPLICATION

This application claims priority to Japanese Patent Application No. 2024-037251 filed on Mar. 11, 2024, incorporated herein by reference in its entirety.

### BACKGROUND

### 1. Technical Field

The disclosure relates to a battery pack.

### 2. Description of Related Art

In a battery module disclosed in Japanese Unexamined Patent Application Publication No. 2023-065217, a plurality of battery cells is disposed in a stacked manner. Moreover, a casing accommodates the battery cells arranged in a horizontal direction. Further, a smoke exhaust cover is located between the battery cells and an upper plate of the casing. A pressure relief valve is provided on the top surface of each battery cell. For example, a short circuit may occur inside the battery cells, and high-pressure gas and debris may be produced, and released through the pressure relief valve. Hereinafter, the phenomenon of gas being released from the pressure relief valve of the battery cells may be simply expressed as the “occurrence of smoke”. The smoke exhaust cover can effectively guide gas ejected from the battery cells when smoke occurs.

### SUMMARY

The inventors of the present application have discovered the following problem. The inventors of the present application have conceived a battery pack in which a cell valve is provided on the bottom surface of each of a plurality of battery cells. A case has a case opening facing the cell valves. A share panel is disposed downward of the case. A smoke exhaust path is formed between the share panel and the case. In such a battery pack, when smoke occurs, gas is ejected from the cell valve of each battery cell, and is guided via the case opening by the share panel and the case. In short, the gas passes through the smoke exhaust path and is discharged. However, the gas has a high calorific value and may have a thermal influence on each structure in the battery pack.

The present disclosure has been made in consideration of the problem, and aims to provide a battery pack that can increase the amount of heat absorbed from gas, and reduce the risk of thermal influence on each structure in the battery pack.

A battery pack according to the present disclosure is mounted on a vehicle, and includes: in a state in which the battery pack is mounted under a vehicle cabin of the vehicle, a plurality of battery cells stacked in a front-rear direction of the vehicle; a case accommodating the battery cells; a cooler having a tube through which a cooling medium is able to flow; and a share panel disposed downward of the case, wherein each of the battery cells has a cell opening and a cell valve, the cell opening is provided in a bottom surface of the battery cell, the cell valve is installed at the cell opening, the case has a case opening communicating with the cell opening, the case opening is provided in a bottom surface of the case, the cooler is installed on a periphery of the case opening, a smoke exhaust path is formed between the case and the share panel, an outer circumferential surface of the tube includes a case contact surface contacting the bottom surface of the case, and a smoke exhaust path surface facing the smoke exhaust path, the case contact surface is substantially flat, and the smoke exhaust path surface protrudes toward the share panel side.

In the battery pack, the cross-sectional shape of the tube may be substantially a trapezoid.

In the battery pack, the cross-sectional shape of the tube may be substantially a parallelogram.

According to the present disclosure, it is possible to increase the amount of heat absorbed from gas, and reduce the risk of thermal influence on each structure in the battery pack.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view of a structural example of a battery pack according to Embodiment 1;

FIG. 2 is a cross-sectional view of a battery module according to Embodiment 1;

FIG. 3 is a top view of the battery pack and a case according to Embodiment 1;

FIG. 4 is a bottom view of the case according to Embodiment 1; and

FIG. 5 is an enlarged cross-sectional view of the battery module according to Embodiment 1.

### DETAILED DESCRIPTION OF EMBODIMENT

A specific embodiment to which the disclosure is applied will be described in detail hereinbelow while referring to the drawings. Note that the disclosure is not limited to the following embodiment. Furthermore, the following description and drawings are simplified, as appropriate, for clarity of explanation.

### Embodiment 1

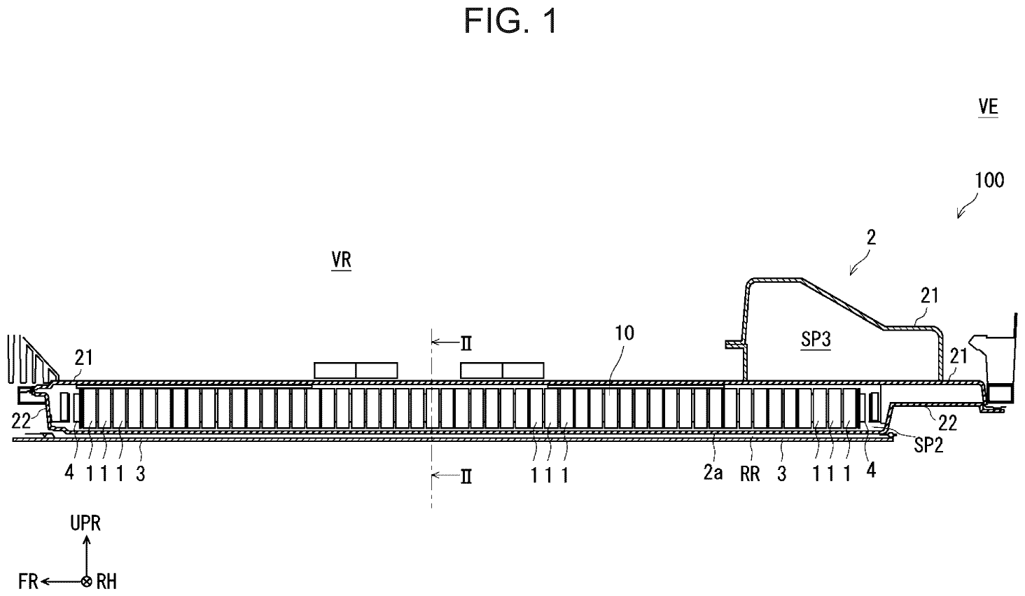

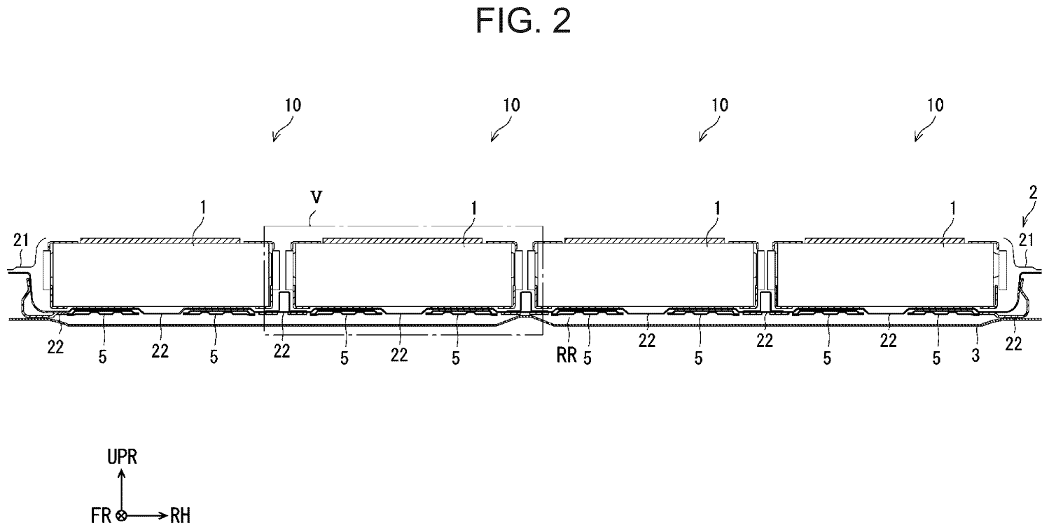

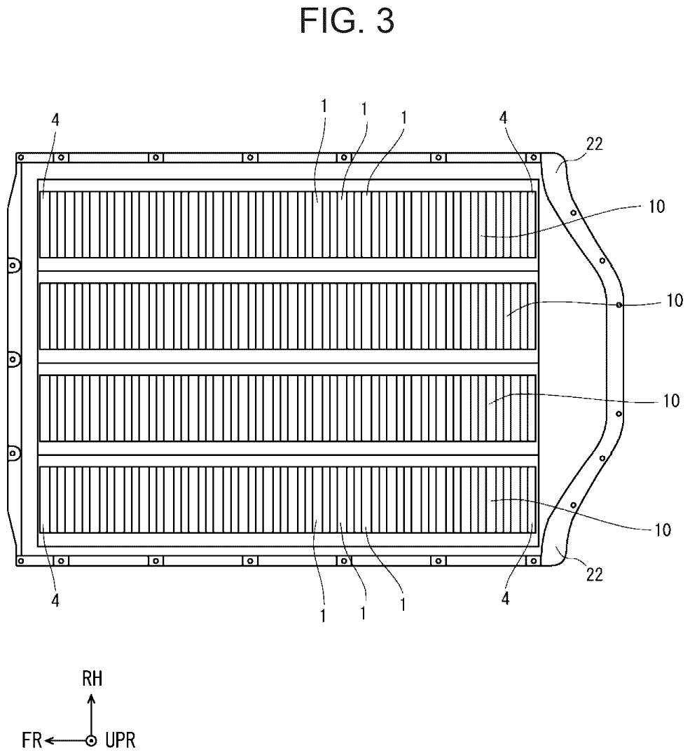

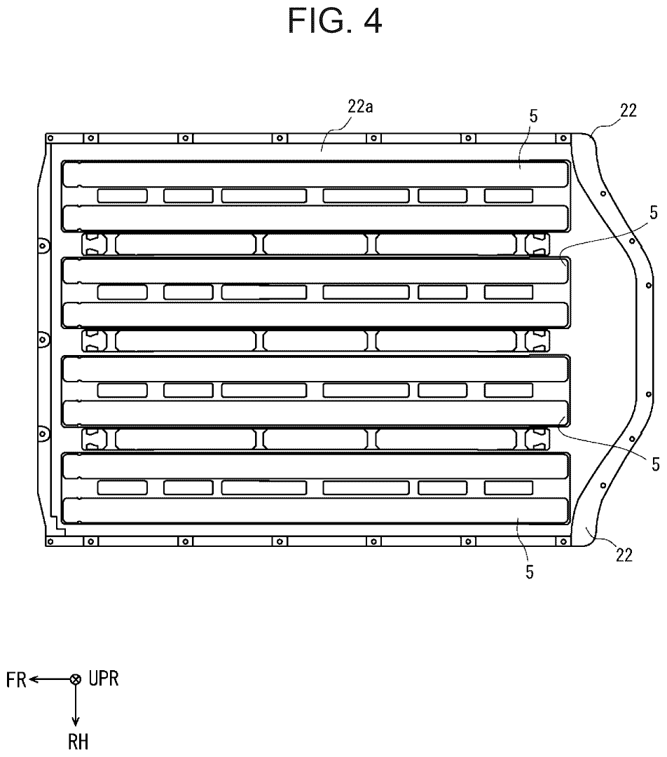

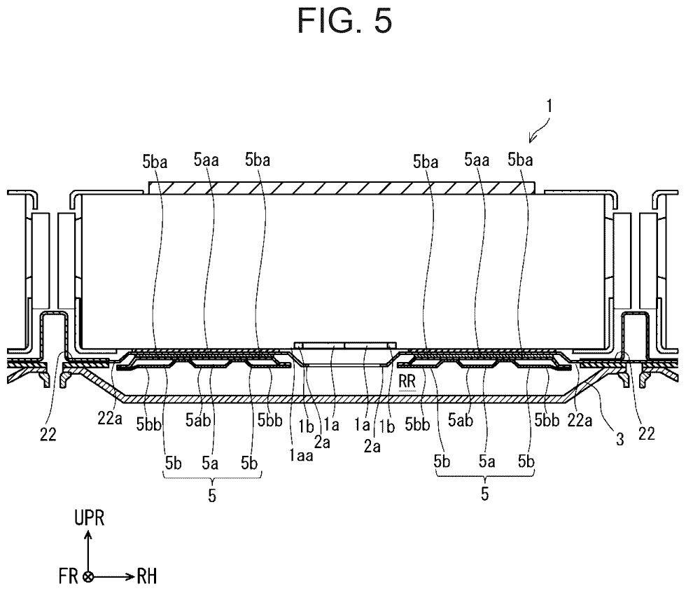

Embodiment 1 will be described with reference to the drawings. FIG. 1 is a schematic cross-sectional view of a structural example of a battery pack according to Embodiment 1. FIG. 2 is a cross-sectional view of a battery module according to Embodiment 1. FIG. 3 is a top view of the battery pack and a case according to Embodiment 1. FIG. 4 is a bottom view of the case according to Embodiment 1. FIG. 5 is an enlarged cross-sectional view of the battery module shown in FIG. 2.

Note that the right-handed XYZ coordinates shown in FIG. 1 and other drawings are, obviously, for convenience in explaining the positional relationships of constituent elements. Normally, the UPR axis positive direction is the vertically upward direction in a vehicle VE, the FR axis positive direction is the forward direction in the vehicle VE, and the RH axis positive direction is the right direction in the vehicle VE. Moreover, a plane including the FR axis and the RH axis is a horizontal plane, which is common among the drawings.

As shown in FIG. 1, a battery pack 100 includes a battery module 10, a case 2, a share panel 3, and a cooler 5 shown in FIG. 2. The battery pack 100 is mounted on a vehicle VE. The battery pack 100 is disposed under a vehicle cabin VR of the vehicle VE.

The case 2 accommodates the battery module 10. The battery module 10 extends in the FR axis direction. The case 2 includes a lower case 22, and an upper case 21. The share panel 3 is disposed downward of the case 2. The share panel 3 can receive input from a road surface while the vehicle VE is traveling. The share panel 3 is disposed spaced apart from the case 2 by a predetermined spacing. The share panel 3 preferably has a size sufficient to cover the case 2. The case 2 and the share panel 3 are preferably formed using metal materials. Such metal materials are, for example, steel and aluminum alloys.

A smoke exhaust path RR is formed between the share panel 3 and the case 2. When smoke occurs, gas is ejected from the battery module 10, and is preferably passed through the smoke exhaust path RR and discharged to the outside of the vehicle VE.

A cell space SP2 is formed between the lower case 22 and the upper case 21. The battery module 10 is accommodated in the cell space SP2.

An equipment space SP3 is formed inside the upper case 21. Equipment constituting the vehicle VE is preferably disposed in the equipment space SP3.

The battery module 10 has a plurality of battery cells 1, and two end plates 4. The battery cells 1 are preferably stacked in the FR axis direction via heat-insulating material or the like. The two end plates 4 preferably hold the battery cells 1 between the end plates 4 with the heat-insulating material or the like interposed therebetween. As shown in FIG. 2 and FIG. 3, the battery modules 10 are disposed side by side in the RH axis direction in the case 2. In one example shown in FIG. 2 and FIG. 3, four battery modules 10 are disposed side by side in the RH axis direction in the case 2. Note that, in FIG. 2, illustration of a central portion of the upper case 21 is omitted. In FIG. 3, illustration of the upper case 21 is omitted.

The cooler 5 is preferably made of a material having good thermal conductivity. Such a material is, for example, aluminum, copper, or an alloy thereof. As shown in FIG. 2 and FIG. 4, the cooler 5 is installed on a bottom surface 22a of the lower case 22. The cooler 5 may contact the bottom surface 22a of the lower case 22 via a thermally conductive adhesive.

As shown in FIG. 5, the battery cell 1 has a cell opening 1b, and a cell valve 1a. The cell opening 1b is provided in a bottom surface 1aa of the battery cell 1. The cell valve 1a is installed at the cell opening 1b. One example of the cell valve 1a shown in FIG. 5 is installed near the center of the bottom surface 1aa of the battery cell 1. A positive terminal and a negative terminal are preferably provided on both side surfaces of the battery cell 1. The case 2 has a case opening 2a communicating with the cell opening 1b. The cell opening 2a is provided in a bottom surface 22a of the lower case 22. The cooler 5 is installed on the periphery of the case opening 2a.

As shown in FIG. 5, the cooler 5 has a tube 5a and a tube 5b. A cooling medium can flow through the tube 5a and the tube 5b. The cross-sectional shape of the tube 5a is substantially a trapezoid. The cross-sectional shape of the tube 5b is substantially a parallelogram. The tube 5a and the tube 5b preferably communicate with each other. The tubes 5a and 5b are preferably supplied appropriately with a cooling medium from a supply source (not shown). The cooling medium preferably circulates through the tube 5a and the tube 5b. The tube 5a and the tube 5b may appropriately discharge the supplied cooling medium. The tube 5a and the tube 5b are disposed on the bottom surface 22a of the lower case 22. The tube 5a and the tube 5b can be disposed along various routes on the bottom surface 22a of the lower case 22. In one example of such a route, the tube 5a and the tube 5b extend so as to cover the bottom surface 22a by repeatedly reciprocating between one end and the other end of the bottom surface 22a. The tube 5a and the tube 5b are preferably formed by pressing against each other a plate-like body having a flat surface and a plate-like 15 body having alternately arranged protruding and recessed portions.

An outer peripheral surface of the tube 5a includes a case contact surface 5aa and a smoke exhaust path surface 5ab. The case contact surface 5aa contacts the bottom surface 22a of the lower case 22, and is substantially flat. The smoke exhaust path surface 5ab faces the smoke exhaust path RR, and protrudes toward the share panel 3 side (here, the UPR axis negative direction). The substantially trapezoidal shape of a cross-section of the tube 5a has a base on the case contact surface 5aa side, and a base on the smoke exhaust path surface 5ab side. The base on the smoke exhaust path surface 5ab side is preferably shorter than the base on the case contact surface 5aa side.

Similarly, an outer peripheral surface of the tube 5b includes a case contact surface 5ba and a smoke exhaust path surface 5bb. The case contact surface 5ba contacts the bottom surface 22a of the lower case 22, and is substantially flat. The smoke exhaust path surface 5bb faces the smoke exhaust path RR, and protrudes toward the share panel 3 side.

Here, the battery cell 1 emits smoke, gas is generated inside the battery cell 1, and the gas reaches the smoke exhaust path RR. Then, the gas contacts the smoke exhaust path surface 5ab of the tube 5a and the smoke exhaust path surface 5bb of the tube 5b, and is cooled. As described above, the case contact surface 5aa of the tube 5a and the case contact surface 5ba of the tube 5b are substantially flat, and the smoke exhaust path surface 5ab of the tube 5a and the smoke exhaust path surface 5bb of the tube 5b protrude toward the share panel 3 side. Therefore, by increasing the area of the smoke exhaust path surface 5ab relative to the area of the case contact surface 5aa of the tube 5a of the cooler 5 and increasing the area of the smoke exhaust path surface 5bb relative to the area of the case contact surface 5ba of the tube 5b of the cooler 5, the amount of heat that the cooler 5 absorbs from the exhaust smoke is increased.

Moreover, the cross-sectional shape of the tube 5a according to the present embodiment is substantially a trapezoid. Further, the cross-sectional shape of the tube 5b according to the present embodiment is substantially a parallelogram. According to these structures, the area of the smoke exhaust path surface 5ab relative to the area of the case contact surface 5aa, and the area of the smoke exhaust path surface 5bb relative to the area of the case contact surface 5ba are increased to increase the amount of heat that the cooler 5 absorbs.

Note that the disclosure is not limited to the above embodiment, and can be appropriately modified within a range not departing from the gist of the disclosure. Furthermore, the disclosure may be implemented by appropriately combining the above-described embodiment and an example thereof.

What is claimed is:

1. A battery pack mounted on a vehicle, the battery pack comprising:
in a state in which the battery pack is mounted under a vehicle cabin of the vehicle, a plurality of battery cells stacked in a front-rear direction of the vehicle;
a case accommodating the battery cells;
a cooler having a tube through which a cooling medium is able to flow; and
a share panel disposed downward of the case, wherein
each of the battery cells has a cell opening and a cell valve,
the cell opening is provided in a bottom surface of the battery cell,
the cell valve is installed at the cell opening,
the case has a case opening communicating with the cell opening,
the case opening is provided in a bottom surface of the case,
the cooler is installed on a periphery of the case opening,
a smoke exhaust path is formed between the case and the share panel,
an outer peripheral surface of the tube includes a case contact surface contacting the bottom surface of the case, and a smoke exhaust path surface facing the smoke exhaust path,
the case contact surface is substantially flat, and
the smoke exhaust path surface protrudes toward the share panel side.

2. The battery pack according to claim 1, wherein a cross-sectional shape of the tube is substantially a trapezoid.

3. The battery pack according to claim 1, wherein a cross-sectional shape of the tube is substantially a parallelogram.
